(19) United States
(12) Patent Application Publication
(10) Pub. No.: US 2008/0223370 A1
(43) Pub. Date: Sep. 18, 2008

(54) Dustproof mask

(76) Inventor: Jong-Hwa Kim, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/008,002

(22) Filed: Jan. 8, 2008

(30) Foreign Application Priority Data
Mar. 13, 2007 (KR) 10-2007-0024291

(51) Int. Cl. A62B 18/00; A62B 7/10

(52) U.S. Cl. 128/206.17; 128/206.12; 128/205.29

(57) ABSTRACT

A dustproof mask that can be used semi-permanently, allows easy respiration and conversation, improves wear comfort and dust preventing effect, and filters harmful air. A mask main body and wearing band, wherein the mask main body includes an adhering piece formed at an inside edge of main body. A fixed frame forms an exhaust space at an inner center. Multiple exhaust holes are formed on both ends of exhaust space. The exhaust panel is inserted in and fixed with fixed frame, having multiple discharge holes. Multiple shield films are formed on the front side of discharge holes and opened at exhalation. A filter cover is formed on both sides of mask main body as a single body. A removable and replaceable filter case is combined with the filter cover. A dustproof nonwoven fabric, carbon filter, antibiotic nano-silver filter, dustproof nonwoven fabric are included in the filter case.

### FIELD OF THE INVENTIONS

This invention relates to a dustproof mask which can be used semi-permanently, enables easy and comfortable respiration and conversation, protects foreign hazardous matters from entering into nostril, prevents moisture from condensing on mask and glass when breathing, improves wear comfort, adhesiveness, and dust preventing effect, and filters hazardous substances in atmosphere.

### BACKGROUND OF THE INVENTION

In general, a large volume of dust is generated in such work environments as paper mill, textile factories, and stone pits, and hazardous gases are discharged from chemical plants, welding works, metallurgic works, plating, or metal processing mills. In our daily living environments also, dust threats our health in subways or on traffic roads.

These dust and/or hazardous gases, when inhaled, may cause serious diseases in lung, such as asthma and etc., therefore, dustproof masks are used in hazardous environments, such as industrial sites, to protect health from dust and/or hazardous matter.

Recently, hemispherical type dustproof masks with paper filter, which are simple and light weighted not to give inconvenience to wearers, cheap priced, and can be used once or several times according to the density of dust in the environment, are commonly used.

These conventional dustproof masks, as shown in FIG. 1, are shaped hemispherically to cover nose and mouth and comprise; mask main body(1) with filtering nonwoven fabric; a shape control plate(2) on upper outer side of said mask main body(1), of which shape can be reformed to fit for nose profile so that said mask main body(1) can be kept close to face; a sponge member(3) on the upper inside of said mask main body(1), contacting with nose to eliminate gap; and bands(4) connected on both sides of said mask main body(1) to hang the mask on ears.

However, conventional dustproof masks can be used only once or for several times by washing, therefore, their costs are high or may cause hygienic problems. In a word, conventional dustproof masks have such structures that cannot b e used over a long time.

In addition, since conventional dustproof masks have 2˜3 layers of nonwoven fabric for filtering, resistance to air flow is high resulting in inconvenience in breathing and talking. Especially, when dust has been accumulated on the filter after a while, such problem becomes worse.

In addition, conventional dustproof masks have such structures that cannot be close to nose profile, giving gaps on both sides of nose, and allowing unfiltered, dusty air infiltrate in.

In addition, when the users wear glasses, humidity in the exhaling breath comes upward through the inside of mask main body (1), condensed on glasses hiding view.

### BRIEF SUMMARY OF THE INVENTION

The purpose of the present invention is to provide a dustproof mask which can improve above described inconveniences of conventional dustproof masks, allows long-term use, easy breathing and talking while wearing, prevents dust and/or hazardous matters in the air by adhering close to face profile, in addition to preventing humidity from condensing on glasses, improves wear comfort, adhesiveness, and dustproofing ability.

To this end, the present invention provides a dustproof mask which is formed with an adhering piece on the inside edge of the mask main body which covers nose and mouth, a fixed frame on inside center of the mask main body to provide an exhaust space, multiple exhaust holes on the front of both sides of said exhaust space, an exhaust panel having multiple discharge holes is inserted in and fixed with said fixed frame, multiple shield films which are opened at breathing-out only on the front of said discharge holes, filter covers on both sides of the mask main body as a single body, combine filter case with said filter cover which can be removed and replaced, and said filter case has dustproof nonwoven fabric, carbon filter, antibiotic nano-silver filter, and dustproof nonwoven fabric layers in said order.

### BRIEF DESCRIPTION OF THE SEVERAL VIEWS OR THE DRAWINGS

FIG. 1 is a perspective drawing of conventional dustproof mask.

FIG. 2 to FIG. 11b show a dustproof mask in accordance with present invention;

FIG. 2 is a perspective drawing of present invention.

FIG. 3 is a front view of present invention.

FIG. 4 is a rear view of present invention.

FIG. 5 is an exploded perspective view of present invention.

FIG. 6 is a planar cross-sectional view of present invention.

FIG. 7 shows an exemplary structure of the exhaust panel and shield film in accordance with present invention.

FIGS. 8a and 8b are cross-sectional views of separated and combined states of the exhaust panel and shield film in accordance with present invention.

FIGS. 9a and 9b are cross-sectional views of the function of the shield film in accordance with the present invention.

FIG. 10 shows an exemplary structure of the filter cover and filter case in accordance with the present invention.

FIGS. 11a and 11b are cross-sectional views of separated and combined states of the filer cover and filter case in accordance with present invention.

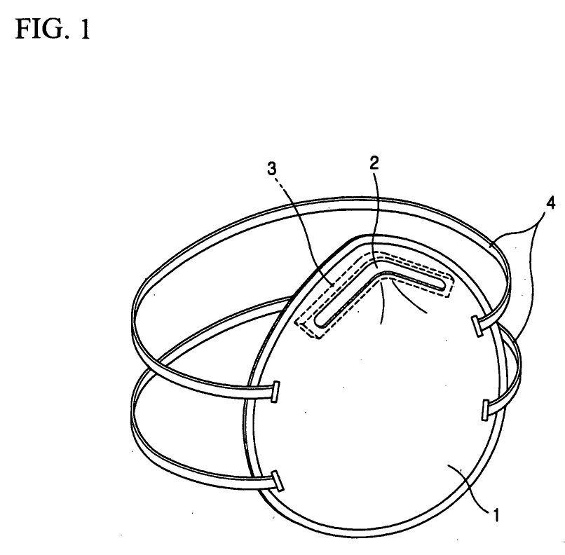

### DETAILED DESCRIPTION OF THE INVENTION

Technical constitution of the present invention is described herein below with reference to attached drawings.

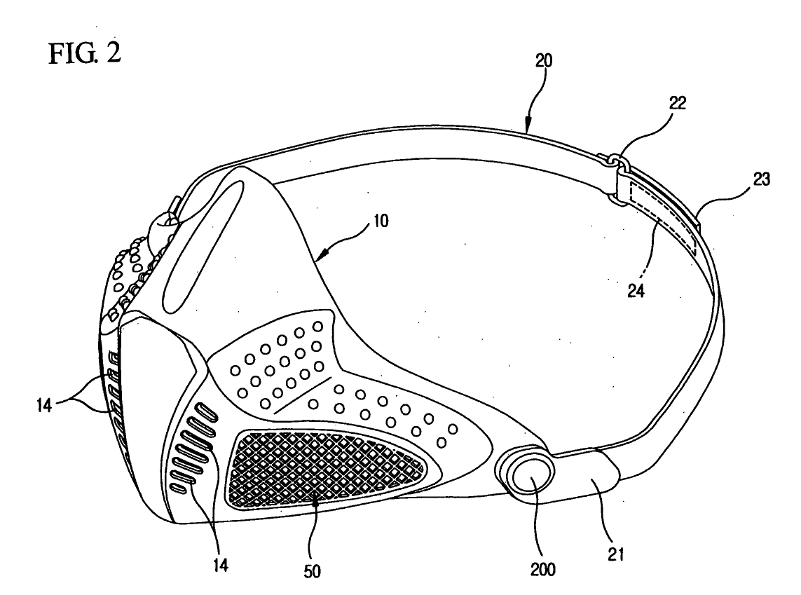

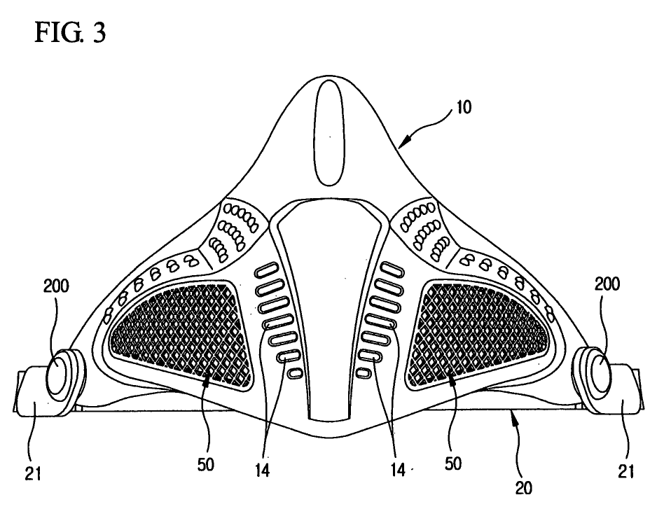

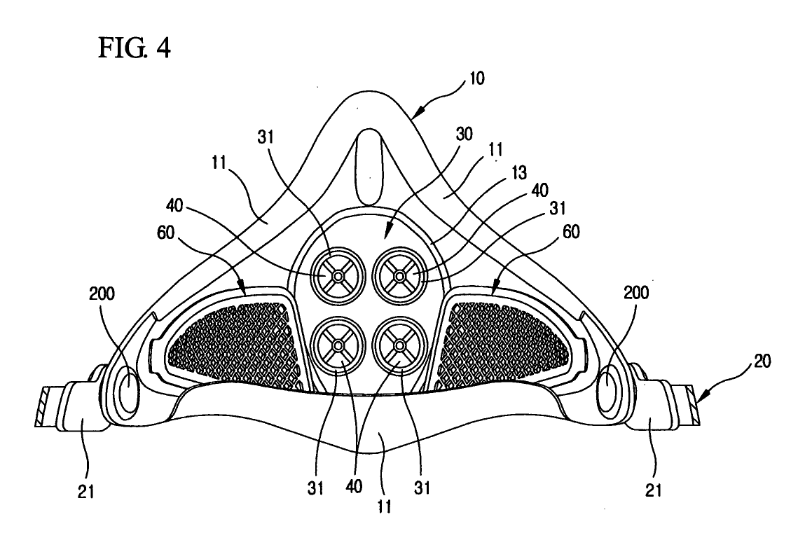

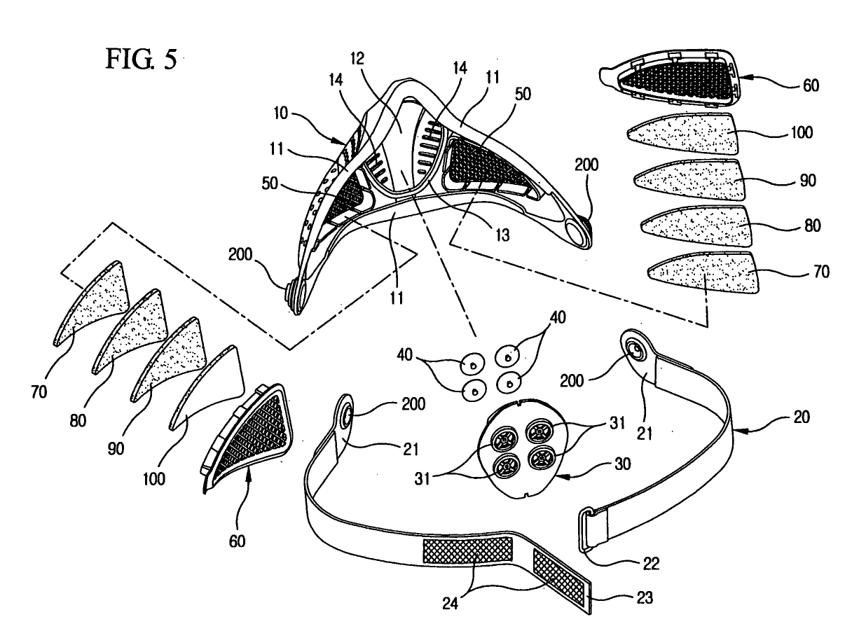

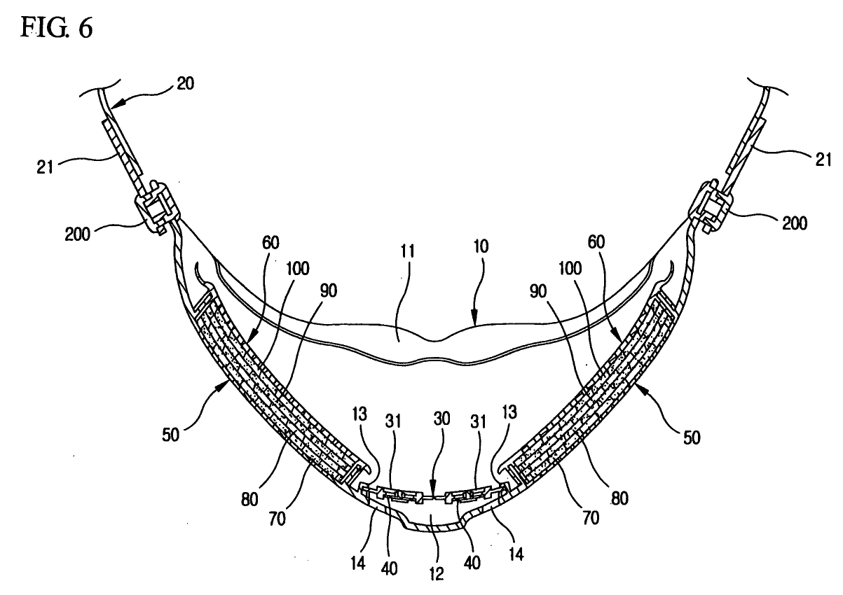

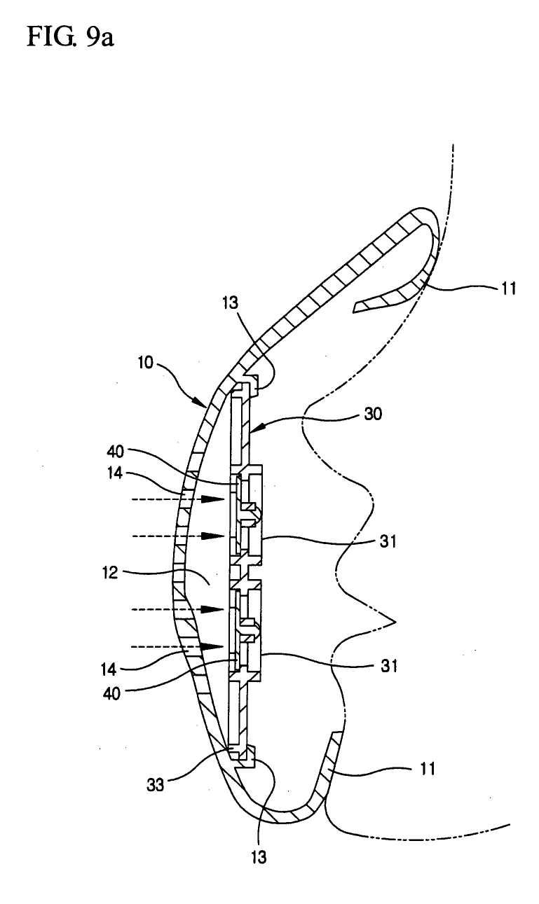

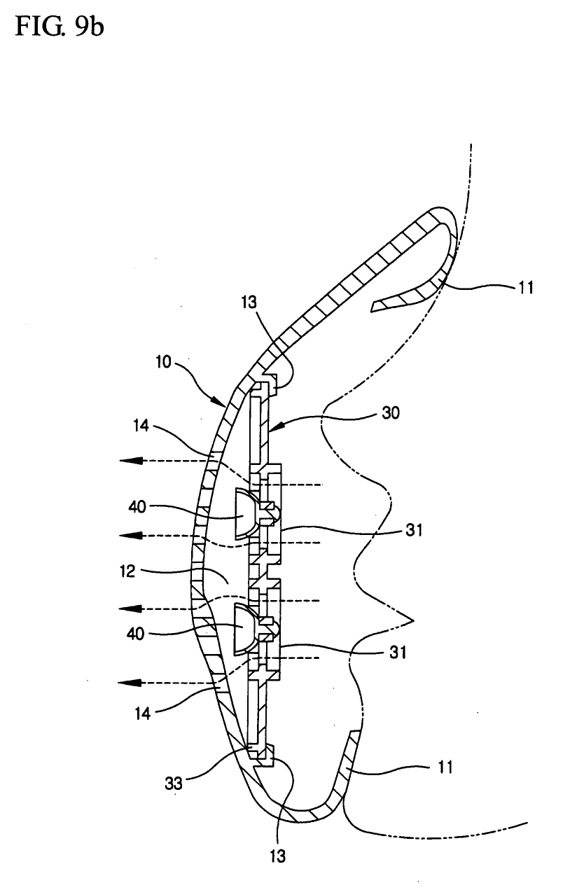

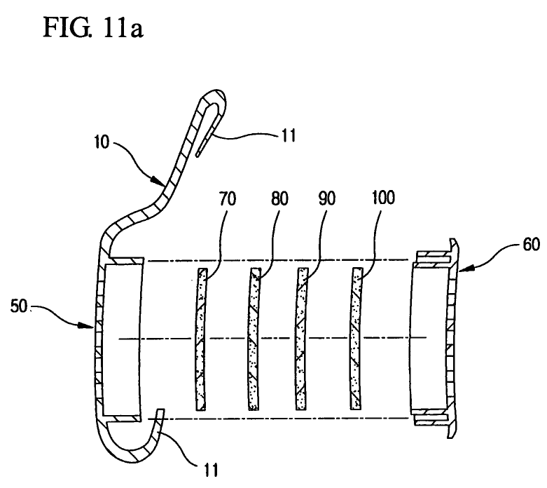

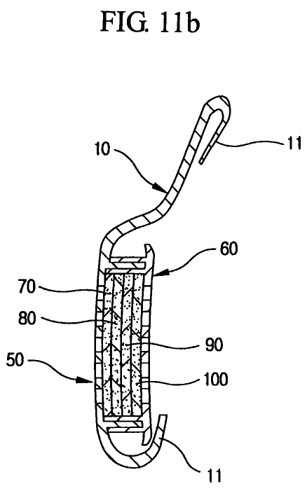

The dustproof mask in accordance with the present invention, as shown in FIG. 2 to FIG. 11b, of which major components are mask main body(10) which is shaped hemispherically to cover nose and mouth and wearing bands(20) on both sides of said mask main body(10), is characterized by being comprised of adhering piece(11) on the inner edge of said mask main body(10); fixed frame(13) on center inside of said mask main body(10) to form exhaust space(12); multiple exhaust holes(14) formed on the front of both sides of said exhaust space(12); exhaust panel(30) with multiple discharge holes(31) and inserted in and fixed with said fixed frame(13); multiple shield films(40) on the front of said discharge hole(31) and opened at breathing out; filter covers(50) on both sides of said mask main body(10); filter case(60) which is combined with said filter cover(50) and removal and replaceable; and the layers of dustproof nonwoven fabric(70),carbon filter(80), antibiotic nano-silver filter(90), and dustproof nonwoven fabric(100) which are laid inside said filter case(60).

Here, said mask main body(10) is formed in hemispherical shape to cover nose and mouth properly, formed with adhering piece(11), exhaust space(12), fixed frame(13), and multiple exhaust holes(14) on the front of both sides. Said mask main body(10) is made with air tight and safe material, preferably flexible rubber to improve wear comfort and allow folding for convenience of carrying and storage.

Said adhering piece(11) is formed on the inner edge of said mask main body(10) and adheres to face of wearer to eliminate gap and prevent infiltration of dust or hazardous matter.

Said exhaust space(12) is formed on center inside of said mask main body(10), and formed with multiple exhaust holes(14) on its front of both sides to discharge out breath air.

Said fixed frame(13) is formed on the center inside of said mask main body(10) to form exhaust space(12), into which exhaust panel(30) is inserted and combined to be removable and replaceable.

Said exhaust holes(14) are formed on the front of both sides of said exhaust space(12) to allow smooth exhaustion of air to out of said mask main body(10).

Said wearing bands(20), which are flexible and elastic, are connected with both sides of the mask main body(10), fixed with joint piece(21) on both ends by high frequency welding method, and snap buttons(200) are provided on said joint piece(21) and the ends of the dustproof mask(10).

At the center of said wearing bands(20) are ring(22) and connector(23) which can be linked together. Said connector(23) is provided with male and female magic tapes(24) which can be separated and jointed for length adjustment. Therefore, link said connector(23) with said ring(22) as shown in FIG. 2, adjust the length of said wearing band(20) appropriately, and combine said magic tape(24) for firm connection of the connector(23).

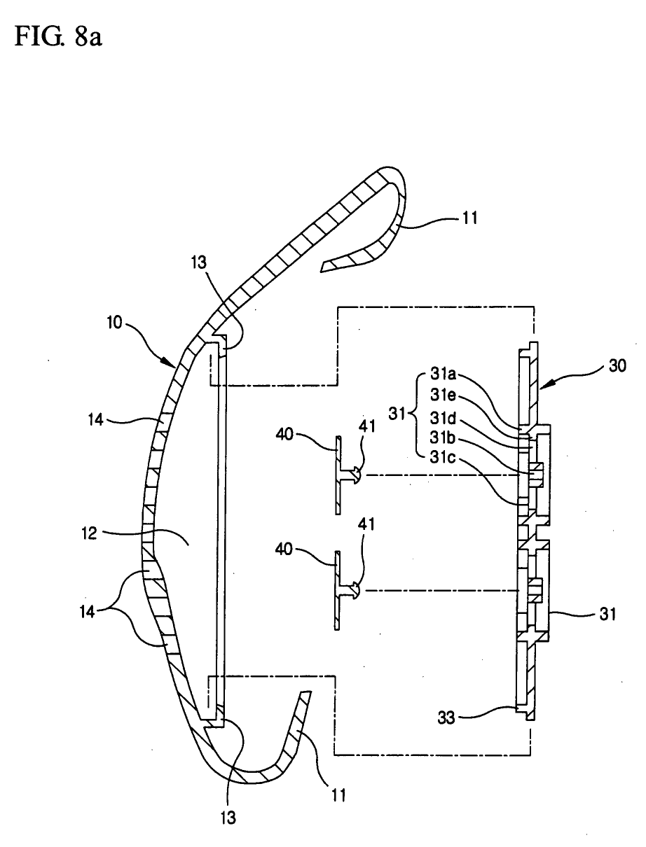

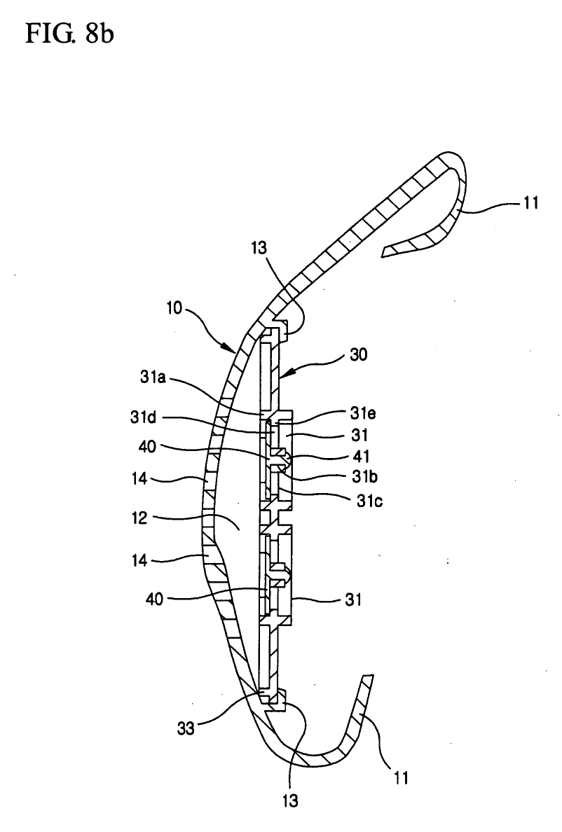

Said exhaust panel(30) is formed with multiple discharge holes(31) and inserted into and fixed with said fixed frame(13). Said exhaust panel(30) is made with air tight and safe material, and can be easily assembled with said fixed frame(13) by pushing in, as shown in FIGS. 8a and 8b, and can also be easily separated from fixed frame(13) by pulling out.

Said exhaust panel(30) is formed with fold line(32) in longitudinal direction and closing rise(33) on front edges. Said fold line(32) allows easy folding of exhaust panel(30) when the mask main body(10) is to be folded in half, and said closing rise(33) is to allow exhaust panel(30) to adhere to fixed frame(13) firmly.

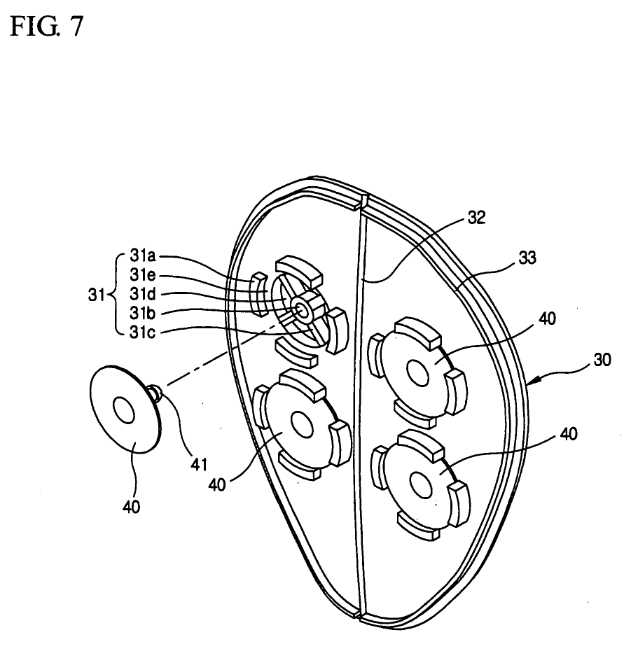

Said discharge hole(31) is formed with circular rise(31a), which is cut at multiple positions to insert shield film(40), as shown in FIGS. 7 and 8a, said discharge hole(31) and shield film(40) are formed with inter-linkable insert hole(31b) and fixing pin(41) at its center, said discharge hole(31) is formed with multiple vent holes(31d) with multiple partitioned support plates(31c) between the holes, and between said vent hole(31d) and circular rise(31a) is formed with contact part(31e) which is in contact with the edge of said shield film(40).

Said shield film(40)s are formed on the front of said discharge holes(31) and opened at out-breath, made with harmless material, and formed with fixing pin(41) which is inserted into and fixed with the insertion hole(31b) of said discharge hole(31). While wearing the dustproof mask in accordance with the present invention, when the user breaths in, said shield film(40) is pressed to the contact(31e) of said discharge hole(31) by air pressure, closing the vent holes(31d), and consequently, the discharge hole(31). When the user breaths out, air is discharged through said vent holes(31d) of said discharge hole(31), pushing shield films(40) so that their edges open up by being separate from contact(31e). Therefore, at out-breaths, shield film(40) is opened to allow smooth discharge of breath air through the vent holes(31d) of discharge holes(31) and the exhaust hole(14) of the main body(10).

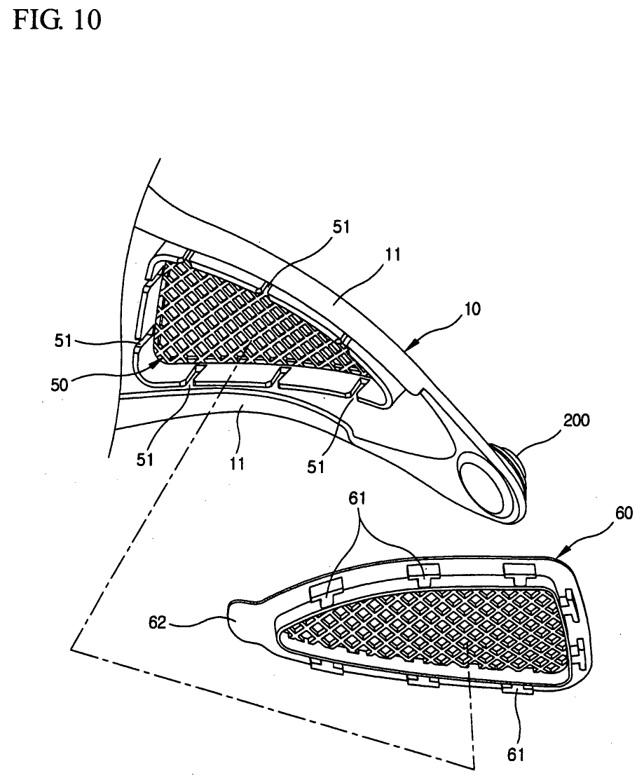

Said filter covers(50) are formed on both sides of the mask main body(10) as a single body, having multiple holes, like a net, for smooth entering of external air, and formed with multiple assembling grooves(51) at certain intervals, as shown in FIG. 10.

Said filter case(60), which is combined with filter cover(50) to be able to be removed and replaced, is formed with multiple holes, like a net, for smooth entering of external air. Said filter case(60) is formed with multiple assembling projections, as shown in FIG. 10, which are assembled with the assembling grooves of said filter cover(50), and a hand grip(62) on one side. Therefore, filter case(60) can be easily assembled with filter cover(50) by holding said grip(62), matching projections(61) with and insert them into said assembling grooves(51), and can be easily separated by holding said grip(62) and pulling out.

Said dustproof nonwoven fabric(70) in said filter case(60) is replaceable, and filters dust and hazardous materials in the air incoming through filter cover(50), as the primary filter.

Said carbon filter(80) in said filter case(60) is replaceable, and filters dust and hazardous materials in the air incoming through filter cover(50), as the secondary filter, radiates far infrared rays and anions, and performs antibiotic and deodorizing functions. For information purpose, carbon is proved to radiate far infrared rays which provide human bodies with such effects as promoting blood circulation and heating, in addition to various effects including antibiotic, heating, neutralizing, circulating, and fermentation. Carbon smoothens operation of inner organs, promotes blood circulation, is good for high blood pressure, diabetes, circulation system, and heart diseases by emitting far infrared rays and anions.

Said antibiotic nano-silver filter(90) in said filter case(60) is replaceable, and filters dust and hazardous materials in incoming air as a third filter, suppresses propagation of bacteria and fungi, and removes bad odor. For information purpose, silver(Ag) has superb antibiotic and sterilizing effect which lasts almost permanently. By providing antibiotic nano-silver filter(90) in filter case(60), propagation of bacteria and fungi can be prevented.

Said dustproof nonwoven fabric(100) in said filter case(60) is replaceable, and filters dust and hazardous materials in the air incoming through filter cover(50), as the 4^{th} filter.

According to the present invention designed and constituted as described herein above, when the wearer inhales through one's nose, with the dustproof mask in accordance with the present invention, filtered, clean air comes in through filter cover(50), dustproof nonwoven fabric(70), carbon filter(80), antibiotic nano-silver filter(90), dustproof nonwoven fabric(100), and filter case(60), and when exhales through nose, air can be exhausted smoothly through vent holes(31d) and exhaust holes(14). When inhaled through mouth, filtered, clean air comes in through filter cover(50), dustproof nonwoven fabric(70), carbon filter(80), antibiotic nano-silver filter(90), dustproof nonwoven fabric(100), and filter case(60), and when exhaled through nose, air can be exhausted smoothly through vent holes(31d) and exhaust holes(14).

Therefore, a dustproof mask in accordance with the present invention allows smooth incoming and outgoing of air through filter cover(50), dustproof nonwoven fabric(70), carbon filter(80), antibiotic nano-silver filter(90), dustproof nonwoven fabric(100), filter case(60) and vent holes(31d) and exhaust holes(14), in addition to good wear comfort, easiness in breathing and talking due to less resistance of air flow, because exhaust panel(30) is separated from mouth and shield films(40) open at breathing out.

In addition, the dustproof mask in accordance with the present invention can prevent dust and hazardous materials from coming in unfiltered because adhering piece(11) provides no gap between the mask and face, and can prevent moisture in the out-breath from condensing on mask main body and glasses(if worn).

In addition, the dustproof mask in accordance with the present invention can be used for a very long time because the dustproof nonwoven fabric(70), carbon filter(80), antibiotic nano-silver filter(90), and dustproof nonwoven fabric(100) in the filter case(60) can be easily replaced.

In addition, the dustproof mask in accordance with the present invention, when compared with conventional dustproof masks, has greatly relieved compression on face while increasing adhesion, providing enhanced wear comfort and dustproofing effect.

In addition, the dustproof mask in accordance with the present invention provides far infrared and anion emission, antibiotic and deodorizing effects with its carbon filter(80), and antibiotic, anti-fungi and deodorizing effects with its nano-silver filter(90).

The dustproof mask in accordance with the present invention has almost permanent lifecycle, enables easy breathing and talking while wearing, prevents incoming of unfiltered dust or other hazardous materials, prevents moisture condensation on mask and glasses, improves wear comfort, adhesiveness, and dustproofing performance.

What is claimed is:

1. For dustproof masks which cover mouth and nose by being formed in hemispherical shape and comprised of mask main body and wearing bands connected with both ends of said mask main body, a dustproof mask which is characterized by being comprised of; adhering piece(11) on inner edges of the mask main body(10); fixed frame(13) forming exhaust space(12) on center inside of said mask main body(10); multiple exhaust holes(14) formed on the front of both sides of said exhaust space(12); an exhaust panel(30) inserted and fixed with said fixed frame(13) and has multiple discharge holes(31); multiple shield films(40) on the front of said discharge holes(31) and opens a exhalation; filter cover(50) on the both sides of said mask main body(10) and form a single body; removable and replaceable filter case(60) combined with said filter cover(50); and dustproof nonwoven fabric(70), carbon filter(80), antibiotic nano-silver filter(90), and dustproof nonwoven fabric(100) which are installed in said filter case(60) in the said order.

2. A dustproof mask in accordance with claim 1, wherein, a dustproof mask which his characterized by being comprised of; on both ends of said wearing band(20) are attached with joint pieces(21), said joint pieces(21) and both ends of the dustproof mask(10) are provide with quick coupling snap buttons(200), center of said wearing band(20) is provided with ring(2) and connector(23) which are not affixed but linked together, and said connector is provided with female and male magic tape(24) for length adjustment.

3. A dustproof mask in accordance with claim 1, wherein, a dustproof mask which his characterized by being formed with fold line(32) in longitudinal direction of the center of said exhaust panel(30) and closing riser(33) on the front edges of said exhaust panel(30).

4. A dustproof mask in accordance with claim 1, wherein, a dustproof mask which his characterized by; circular rise(31a), which has multiple cut grooves in which said shield films(40) are inserted, is formed on the front of said discharge holes(31); in the centers of said discharge holes(31) shield films(40) are formed with insertion holes(31b) and fixing pins(41) which can be jointed together; said discharge holes(31) are formed with multiple vent holes(31d) with multiple partitioned support plates(31c) between them; and contact(31e) which contacts the edge of said shield film(40) is formed between said vent hole(31d) and circular rise(31a).

5. A dustproof mask in accordance with claim 1, wherein, a dustproof mask which his characterized by; multiple assembling grooves(51) at certain intervals on said filter cover(50); said filter case(60) is formed with multiple assembling projections(61) which are assembled with assembling holes(51); and said filter case(60) is formed with hand grip(62) on a side.
